(19) United States
(12) Patent Application Publication
(10) Pub. No.: US 2006/0161778 A1
(43) Pub. Date: Jul. 20, 2006

(54) Distinguishing between devices of different types in a wireless local area network (WLAN)

(75) Inventors: Vlad Stirbu, Tampere (FI); Mika Saaranen, Tampere (FI); Holger Hussmann, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/813,727

(22) Filed: Mar. 30, 2004

Related U.S. Application Data
(60) Provisional application No. 60/557,731, filed on Mar. 29, 2004.

(51) Int. Cl. H04L 9/00

(52) U.S. Cl. 713/176; 713/320

(57) ABSTRACT

A method and system for distinguishing between devices of different types (e.g., mobile and stationary devices) in a wireless local area network (WLAN) in order to provide additional services to one or the other. The method includes obtaining a device type for the terminal, and providing specific services to the terminal if the terminal is a device of a certain type.

### FIELD OF THE INVENTION

The present invention relates to systems and methods for wireless network communications. More specifically, the present invention relates to distinguishing between devices of different types in a wireless local area network (WLAN).

### BACKGROUND OF THE INVENTION

Wireless networks can include a wireless local area network (WLAN). A series of standards for wireless local area networks (WLANs) known as the IEEE 802.11 standards have been widely adopted and gained acceptance. In general, the IEEE 802.11 standard for WLANs is a standard for systems that operate in the 2,400-2,483.5 MHz band. It provides 1 to 2 Mbps transmission. The 802.11 RF transmissions use multiple signaling schemes (modulations) at different data rates to deliver a single data packet between wireless systems.

The 802.11a standard is an extension to 802.11 that applies to wireless LANs and provides up to 54 Mbps in the 5 GHz band. The 802.11b standard (also referred to as 802.11 High Rate or Wi-Fi) is an extension to 802.11 that applies to wireless LANs and provides 11 Mbps transmission (with a fallback to 5.5, 2 and 1 Mbps) in the 2.4 GHz band. The 802.11g standard applies to wireless LANs and provides 20+ Mbps in the 2.4 GHz band.

The original purpose of IEEE 802.11 was to provide a wireless option for local area networks. The idea was to provide wireless connectivity to automatic machinery, equipment, or stations that require rapid deployment, which may be portable or hand-held, or which may be mounted on moving vehicles within a local area. Currently, 802.11 has been extended to cases similar to cellular connectivity, but for providing broadband connectivity on wireless hotspots like homes, hotels, airport, and offices. During this evolution, handheld devices like PDAs or mobile phones like the Nokia 9500 communicator from Nokia Corporation are deploying WLAN for broadband access.

As a wireless communication medium, IEEE 802.11 starts with assumption that devices are either portable or mobile devices. IEEE 802.11 was originally intended for portable use cases, where devices using WLAN can be freely relocated, but used in a stationary position. Mobile devices, however, bring a new problem, as these devices communicate while also moving. Further, energy saving requirements of such devices are stricter than for portable devices. Hence, it is not sufficient to handle all devices as portable stations.

Unfortunately, physical means of detecting mobile devices is not easy. In many cases, sophisticated algorithms are needed to detect mobile devices. However, 802.11 already provides a sophisticated MAC layer functionality that can be used to distinguish between different kind of terminals. Further, power management is an important consideration for mobile stations because they are often battery powered.

UPnP (Universal Plug and Play) technology defines architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and the Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices.

The Digital Home Working Group (DHWG) was introduced in June 2003 as a cross-industry organization of leading consumer electronics, computing industry, and mobile device companies established to develop guidelines to provide consumer equipment (CE), mobile, and personal computer (PC) vendors with information needed to build interoperable digital home platforms, devices, and applications. The DHWG defines implementation guidelines for digital home devices, which will be interconnected with IP networking technology.

The DHWG HNv1 (Home Network version 1) guidelines describe an environment formed by devices like PCs, TV sets, set-top boxes, stereo systems, etc. that are connected to the network via a 802.x interface (e.g., Ethernet and WLAN). The devices that form the HNv1 are by their nature static or with very limited mobility allowing them to be always connected to an AC power supply. At the same time, the connectivity technology they are using allows high data rates and low latency.

Constrained devices like mobile phones, PDAs, portable music players are not able to interact with HNv1 devices because they support a different radio technology (usually Bluetooth) and their power supply is also limited. Therefore, in order to interoperate with devices from HNv1 they need an IWU (Interworking Unit). At the same time the nature of the UPnP protocols makes the interworking for a constrained device very expensive in terms of battery lifetime. The behavior of these devices is described in the guidelines released by DHWG Mobile Handheld Subcommittee (MHS).

In addition to HNv1 fully compliant devices and MHS constraint devices, there is a third class of devices equipped with HNv1 communication medium, but unable to fulfill media, or signaling requirements. Therefore, there is a need to recognize these devices and provide specific services for these third class devices. Examples of this kind of devices are PDAs with WLAN card, such as the Hewlett Packard IPAQ PDA or the Nokia 9500 device. These devices are partially able to function in HNv1 network, but at least energy saving requirements force them to have separated processing at APs. Therefore, there is a need to identify these devices and provide different processing over single physical medium. Even further, there is a need for a WLAN access point that distinguishes between devices of different types (e.g., mobile and stationary devices) to be able to provide distinct services for one and the other.

### SUMMARY OF THE INVENTION

The present invention is directed to using an access point that provides additional services to attached nodes based on what type of node they are, enabling them to function in an energy efficient way. One such additional service is a filtering service for UPnP messages. The access point provides a separated service set for MHS devices having HNv1 communication medium, but being in some other ways a constraint device.

Briefly, one exemplary embodiment relates to a method for communication in a wireless local area network (WLAN) in which a WLAN access point distinguishes between different device types to provide additional services to one type of device. The method includes obtaining a device type for the terminal, and providing device type-specific services to the terminal if the terminal is a first device type.

Another exemplary embodiment relates to a system for determining device types and providing services for different device types. The system includes a supplicant node coupled to a wireless local area network (WLAN) and an access point associated with the WLAN. The access point determines what device type the supplicant node is. The access point provides different services to the supplicant node if it is a first device type.

Yet another exemplary embodiment relates to a system for communication in a wireless local area network (WLAN) in which a WLAN access point distinguishes between different device types in order to provide additional services to one type of device. The system includes means for obtaining a device type for the terminal, and means for providing device type-specific services to the terminal if the terminal is a first device type.

Another exemplary embodiment relates to a method for device type differentiation in a wireless local area network (WLAN) access point. The method includes obtaining a terminal device type corresponding to a terminal in the wireless area network and providing services specific to the terminal device type to the terminal.

Another exemplary embodiment relates to a wireless local area network (WLAN) access point that provides device type differentiation. The access point includes means for obtaining a terminal device type corresponding to a terminal in the wireless area network and means for providing services specific to the terminal device type to the terminal.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a diagrammatic representation of a system including a local area network (LAN) and an IEEE 802.1x framework mobile in accordance with an exemplary embodiment.

FIG. 2 is a diagrammatic representation of a system where the authenticator function is co-located with the authentication server function and they are implemented inside a WLAN Access Point in accordance with an exemplary embodiment.

FIG. 3 is a diagram depicting an access point with mobile detection and mobile-specific services in accordance with an exemplary embodiment.

FIG. 4 is a diagram representing mobility detection plug-ins in accordance with an exemplary embodiment.

### DETAILED DESCRIPTION OF EXEMPLARY EMBODIMENTS

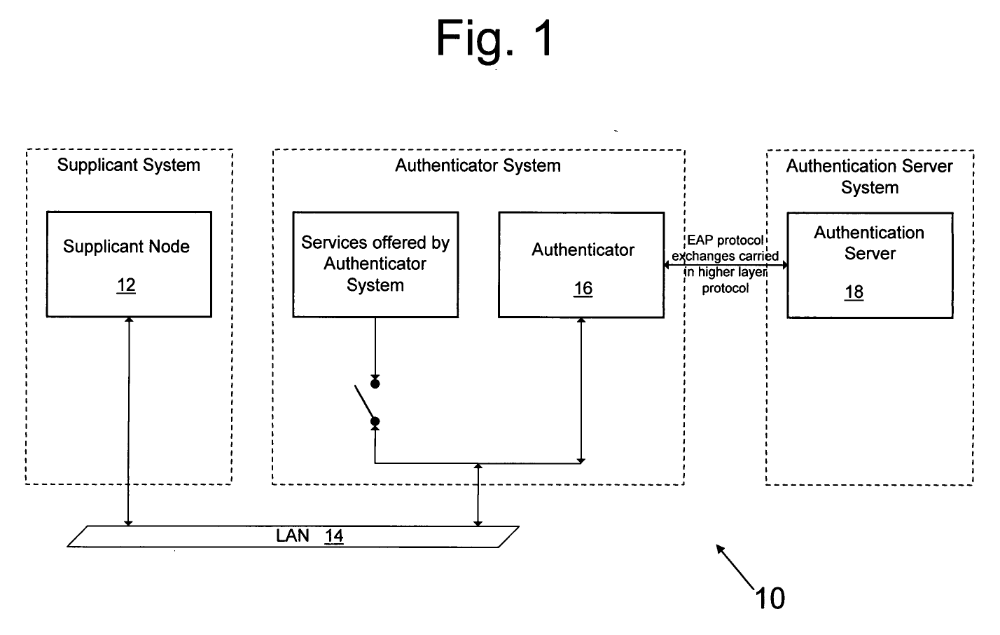

FIG. 1 illustrates a system 10 including a local area network (LAN) and an IEEE 802.1x framework. A supplicant node 12 requests access to an authenticator or access point 16. The authenticator 16 discovers what nodes are stationary and what nodes are mobile and provides additional services only to the mobile devices. Alternatively or additionally, some additional services may only be for stationary devices. An example additional service for mobile devices is the filtering service for UPnP messages.

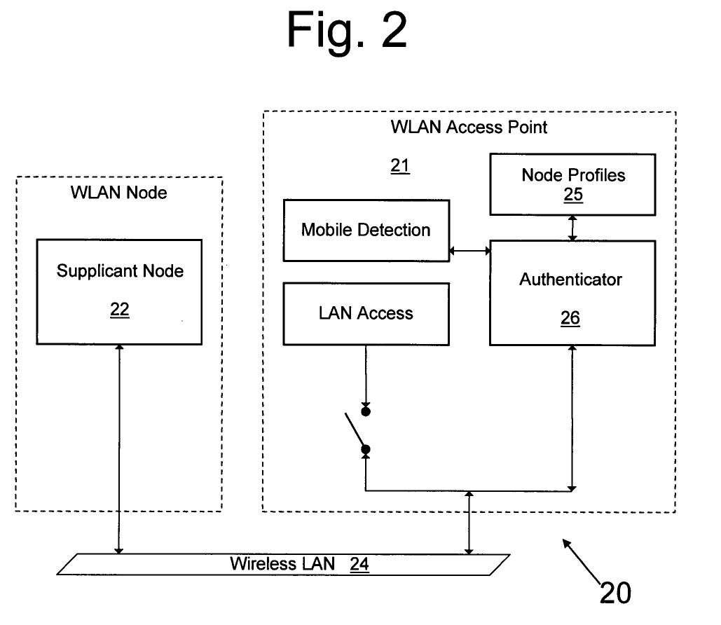

The authenticator 16 can discover whether the attached node is a static or a mobile device. This determination can be made by listening to the signal strength and propagation delays from the device. For example, if the device is moving frequently, it is a mobile device. Alternatively, as described below with reference to FIG. 2, the determination can be made by storing a device type in a profile associated with the authentication data in an 802.1X environment. When the node authenticates, the access point fetches the device type from the profile. Yet another way to make the determination is, if the device uses IEEE 802.11 power save mode, the power save mode can be used as signal to indicate a mobile device. Adding this feature to the authenticator 16 in FIG. 1 turns the mobile operation on for any device using power save mode.

The 802.1X standard enhances the security of local area networks (LANs). Moreover, 802.1X provides an authentication framework for wireless LANs, allowing a user to be authenticated by a central authority. 802.1X uses an existing protocol, the Extensible Authentication Protocol (EAP), that works on Ethernet, Token Ring, or wireless LANS, for message exchange during the authentication process.

The authenticator 16 forces the node 12 into an unauthorized state that allows the client to send only an EAP start message. The access point 16 returns an EAP message requesting the user's identity. The client returns the identity, which is then forwarded by the access point to an authentication server 18, which uses an algorithm to authenticate the user and then returns an accept or reject message back to the access point. Assuming an accept was received, the access point 16 changes the client's state such that authorized and normal traffic can take place.

In at least one exemplary embodiment, the authentication server 18 uses the Remote Authentication Dial-In User Service (RADIUS) for communicating with authenticator, although 802.1X does not specify it. The DIAMETER based protocol can also be used. The access point 16 and the authentication server 18 can be co-located within the same system, allowing that system to perform the authentication function without the need for communication with an external server.

FIG. 2 illustrates a system 20 having a wireless LAN 24 where an authenticator function is co-located with the authentication server function and are implemented inside a WLAN Access Point 21. During the initial security initialization, the owner of the node 22 configures the security parameters and assigns a “device class” to the node 22, e.g. stationary or mobile. These parameters can be stored in the access point 21 as a node profile 25 for that node. The initialization is done only once during the first use of the device in the home environment.

In an exemplary embodiment, during normal operation, the access point 21 can detect the node class based on successful 802.1X authentication. Mobile terminals can be detected in several different ways. One way is to use static information stored in a user database that is used by 802.1X authentication/access control. When a mobile device attaches to a network, it needs to first associate with local network. Using the authentication procedure, it is possible to detect which nodes are mobile by adding this information into the profiles of the devices (e.g., user/device information) and, during association, the information is transmitted into the access point 21 that can then start mobile-specific services like this filtering.

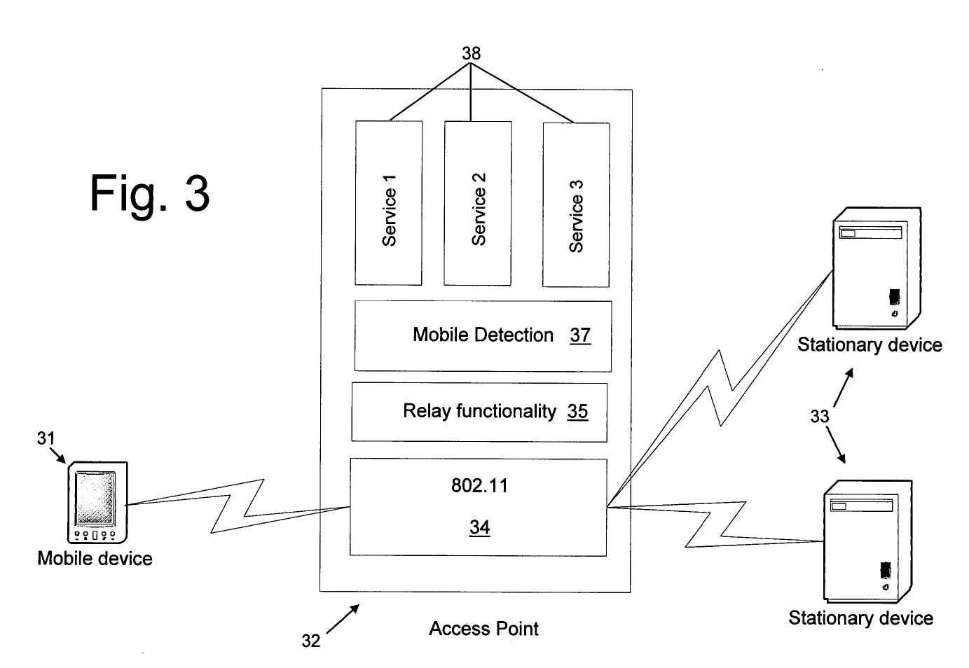

FIG. 3 illustrates an access point 32 with mobile detection and mobile-specific services for devices, such as mobile device 31 and stationary devices 33. The access point 32 includes an 802.11 interface 34, a relay functionality 35, a mobile detection module 37, and services 38. The mobile detection module 37 performs operations described herein to determine whether nodes communicating with the access point 32 are mobile or stationary. Different services 38 can then be provided to the nodes, depending on whether they are mobile or stationary devices.

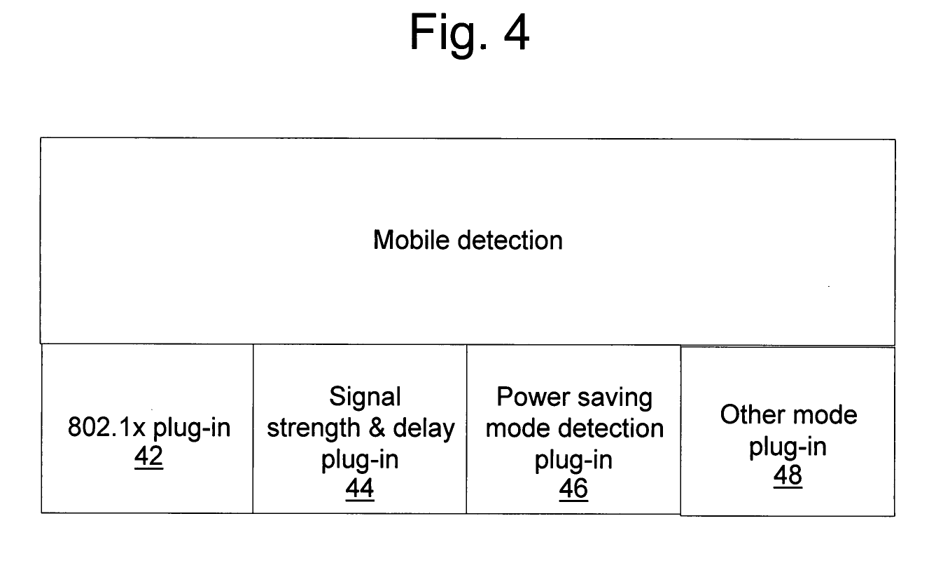

FIG. 4 illustrates mobility detection plug-ins that can be used in the systems, devices, and methods described with reference to FIGS. 1-3. These plug-ins are software modules that can be plugged in or added to the mobile detection software operating at the access point. These plug-ins can include an 802.1X plug-in 42, a signal strength and delay plug-in 44, a power saving plug-in 46, and an other mode plug-in 48. Other plug-ins may also be used. These plug-ins provide enhanced capability that can be used by an access point to determine whether a node is a stationary or a mobile device.

In some cases, it is more beneficial to use more dynamic approach. Additional features can be included in the access point to monitor certain parameters in the attached terminal's communication. For example, the 802.11 power saving mode signals can be used for initiating mobile-specific services. In operation, the mobile terminal signals the access point that it is in power save mode. Once a device is in power save mode, incoming communication packets to the device are buffered at the access point. When the terminal queries if there are packets to be delivered, the access point delivers the packets.

In actual implementation, the mobility detection can happen during association or it can happen later in operation. After mobility detection has occurred, the access point treats packet flow differently for this terminals MAC address. Physical layer information, such as propagation delay and signal strength, can also be used to detect which devices are mobile and will use mobile specific services.

Advantages of the implementations described with reference to the FIGURES are many. First, the additional services enable longer battery lifetime for the mobile devices attached to the access point. Second, other service differentiation is possible. Moreover, it exploits already existing buffering mechanism needed for any access point. Further, the access point only needs to use one radio interface for both stationary and mobile devices.

The implementations described herein can be identified when used in wireless communication systems. For example, inspection of the communication traffic between an access point and a stationary device can be compared to the communication traffic between the access point and a mobile device. If messages, such as a UPnP multi-cast messages, are forwarded to the stationary device but not to the mobile device, the system utilizes the implementations described herein. More generally, if communication to the same HN1 server is different depending on whether the device is stationary or mobile, the techniques presented here are in use. Generally, multicasting is an IP network technique, where one stream is transmitted to multiple destinations. Local multicasting is used, for example, in UPnP and also in Ipv6.

This detailed description outlines exemplary embodiments of a method, device, and system for a WLAN access point that distinguishes between mobile and stationary devices in order to provide additional services to one or the other. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the FIGURES and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

What is claimed is:

1. A method for distinguishing between device types in a wireless local area network (WLAN) in order to provide additional services to one type of device, the method comprising:
obtaining a device type for a terminal in a wireless local area network; and
providing device type-specific services to the terminal if the terminal is a first device type.

2. The method claim 1, wherein obtaining a device type for the terminal comprises fetching a device type associated with the terminal from a device profile.

3. The method of claim 2, wherein the device profile is stored in memory at a WLAN access point.

4. The method of claim 1, wherein obtaining a device type for the terminal comprises identifying if the terminal uses a power save mode.

5. The method of claim 1, wherein obtaining a device type for the terminal comprises retrieving static information in a user database used in the authentication procedure.

6. The method of claim 1, wherein obtaining a device type for the terminal comprises receiving the device type during the authentication procedure for the terminal.

7. The method of claim 1, further comprising:
requesting identity of a terminal in a wireless local area network (WLAN) system;
receiving a response to the identity request;
authenticating the terminal based on the received response to the identity request;

8. The method of claim 7, wherein the authentication procedure comprises the Extensible Authentication Protocol (EAP).

9. The method of claim 7, wherein the authentication procedure comprises the Remote Authentication Dial-In User Service (RADIUS).

10. The method of claim 1, further comprising forcing the terminal into an unauthorized state which allows the terminal to only send an Extensible Authentication Protocol (EAP) start message.

11. The method of claim 1, wherein obtaining a device type for the terminal comprises detecting the device type from a propagation and signal information from the terminal.

12. The method of claim 1, wherein obtaining a device type for a terminal comprises receiving a signal initiated by the terminal, wherein the signal provides device type information.

13. The method of claim 1, further comprising utilizing a plug-in module to enhance the ability to determine whether the terminal is a stationary device or a mobile device.

14. The method of claim 13, wherein the plug-in module comprises any one of an 802.1X plug-in, a signal strength and delay plug-in, and a power saving plug-in.

15. A system for determining device types and providing services for the device types, the system comprising:
a supplicant node coupled to a wireless local area network (WLAN); and
an access point associated with the WLAN, the access point determining what device type the supplicant node is, wherein the access point provides different services to the supplicant node if it is a first device type.

16. The system of claim 15, wherein the access point comprises node profiles including information on which nodes in the WLAN are devices are mobile devices and which nodes in the WLAN are stationary devices.

17. The system of claim 15, wherein the access point determines what type of device the supplicant node is during the authentication process by which the supplicant node authenticates itself.

18. The system of claim 15, wherein the access point determines what type of device the supplicant node is by identifying if the supplicant node uses a power save mode.

19. A system for communication in a wireless local area network (WLAN) in which a WLAN access point distinguishes between different device types to provide additional services to one type of device, the system comprising:
means for obtaining a device type for the terminal; and
means for providing device type specific services to the terminal if the terminal is a first device type.

20. The system of claim 19, further comprising:
means for requesting identity of a terminal in a wireless local area network (WLAN) system;
means for receiving a response to the identity request;
means for authenticating the terminal based on the received response to the identity request;

21. The system of claim 19, wherein the device type is contained in a node profile at an access point in the WLAN system.

22. The system of claim 19, wherein the specific services to the terminal comprise multicast filtering.

23. The system of claim 22, wherein the multicast filtering is provided to protect devices from Universal Plug and Play (UPnP) messages.

24. The system of claim 19, further comprising means for forcing the terminal into an unauthorized state which allows the terminal to only send an Extensible Authentication Protocol (EAP) start message.

25. The system of claim 19, wherein means for obtaining a device type for the terminal comprises means for identifying if the terminal uses a power save mode.

26. The system of claim 19, wherein means for obtaining a device type for the terminal comprises means for receiving the device type during the authentication procedure for the terminal.

27. A method for device type differentiation in a wireless local area network (WLAN) access point, the method comprising:
obtaining a terminal device type corresponding to a terminal in the wireless area network; and
providing services specific to the terminal device type to the terminal.

28. The method of claim 27, wherein the terminal device type is stored in a node profile in the WLAN access point.

29. A wireless local area network (WLAN) access point that provides device type differentiation, the access point comprising:
means for obtaining a terminal device type corresponding to a terminal in the wireless area network; and
means for providing services specific to the terminal device type to the terminal.

30. The access point of claim 29, further comprising means for utilizing a plug-in module to enhance the ability to determine whether the terminal is a stationary device or a mobile device.

31. The access point of claim 30, wherein the plug-in module comprises any one of an 802.1X plug-in, a signal strength and delay plug-in, and a power saving plug-in.

32. The access point of claim 29, further comprising means for authenticating the terminal.

33. The access point of claim 29, further comprising node profiles containing terminal device type information.
